(19) United States
(12) Patent Application Publication
(10) Pub. No.: US 2022/0351096 A1
(43) Pub. Date: Nov. 3, 2022

(54) System for Providing Professional Consulting Services

(71) Applicant: Cognitient Corp., Newark, DE (US)

(72) Inventors: Richard Cocchiara, Washingtonville, NY (US); Howard Fields, Greenwich, CT (US); Richard Iler, Broadview Heights, OH (US)

(21) Appl. No.: 17/243,831

(22) Filed: Apr. 29, 2021

(51) Int. Cl. G06Q 10/06; G06F 16/2457; G06N 5/02

(52) U.S. Cl. CPC G06Q 10/0633; G06F 16/24573; G06N 5/022; G06Q 10/0639; G06Q 10/0637

(57) ABSTRACT

A system for providing professional consulting services is described, having a computer, a database including a plurality of models each containing prompts and analytics in data communication with said computer, a consultant device in data communication with said computer, the computer receiving a selection of at least one of said plurality of models from said consultant device, a user device associated with a company, the computer transmitting prompts from the selected model to said user device, responses received by said computer from said user device in reply to the selected model prompts, and a score generated by said computer comparing the responses to the analytics for the selected model.

### TECHNICAL FIELD

The present invention relates to a novel system for providing professional consulting services. Specifically, the system is used for providing risk identification and mitigation consulting services.

### BACKGROUND

Traditional consulting services can require weeks to effectively prepare, interview employees, conduct analyses, and prepare reports and recommendations. Once recommendations are implemented, the process may be required to begin anew.

Moreover, traditional consulting services rely solely on the knowledge and experience of the consultant, without any way to leverage the knowledge and experience of other consultants without directly involving them. As such, junior consultants require the involvement and/or supervision of more senior consultants.

Consulting reports are also delivered in a static format, often without any room for user engagement, consideration of incremental improvements, or ability for the consultant to quickly monitor progress.

### SUMMARY

For these and other reasons known to a person of an ordinary skill in the art, what is needed is a system for providing professional consulting services.

A goal of the present invention is to provide a system to evaluate knowledge, experience, and past performance (“KEP”).

Another goal of the present invention is to enable companies, organizations, and government agencies to mitigate the risks associated with their technology, projects, processes, initiatives, business, and organization.

Another goal of the present invention is to provide a dashboard by which a user can view reports, provide improvement information, view updated reports, and allow a consultant to monitor progress.

Another goal of the present invention is to improve the timeframe by which professional consulting services are provided.

Another goal of the present invention is to leverage the knowledge and experience consultants, in part by making use of prior anonymized engagement data.

In one aspect of the present invention, a system for providing professional consulting services is provided, having a computer, a database including a plurality of models each containing prompts and analytics in data communication with said computer, a consultant device in data communication with said computer, the computer receiving a selection of at least one of said plurality of models from said consultant device, a user device associated with a company, the computer transmitting prompts from the selected model to said user device, responses received by said computer from said user device in reply to the selected model prompts, and a score generated by said computer comparing the responses to the analytics for the selected model.

### BRIEF DESCRIPTION OF THE DRAWINGS

FIG. 1 shows a schematic diagram of the presently disclosed system.

FIG. 2 shows a schematic diagram of an exemplary database and database access configuration the presently disclosed system.

FIG. 3 shows a schematic diagram of the presently disclosed system.

FIG. 4 shows a schematic diagram of an exemplary database and database access configuration the presently disclosed system.

### DETAILED DESCRIPTION

The present invention will now be described by referencing the appended figures representing the preferred embodiment.

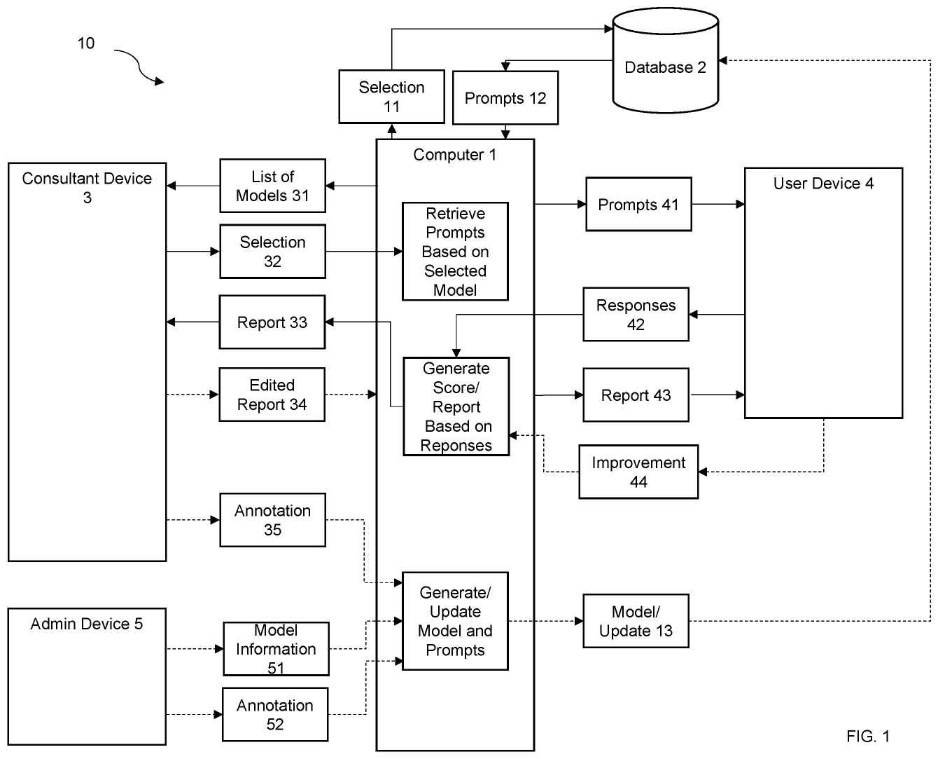

Referring to FIG. 1, the present disclosure describes a system 10 for providing professional consulting services.

The system 10 includes a computer 1. The computer 1 may be a processor, remote computer, computer server, network, or any other computing resource.

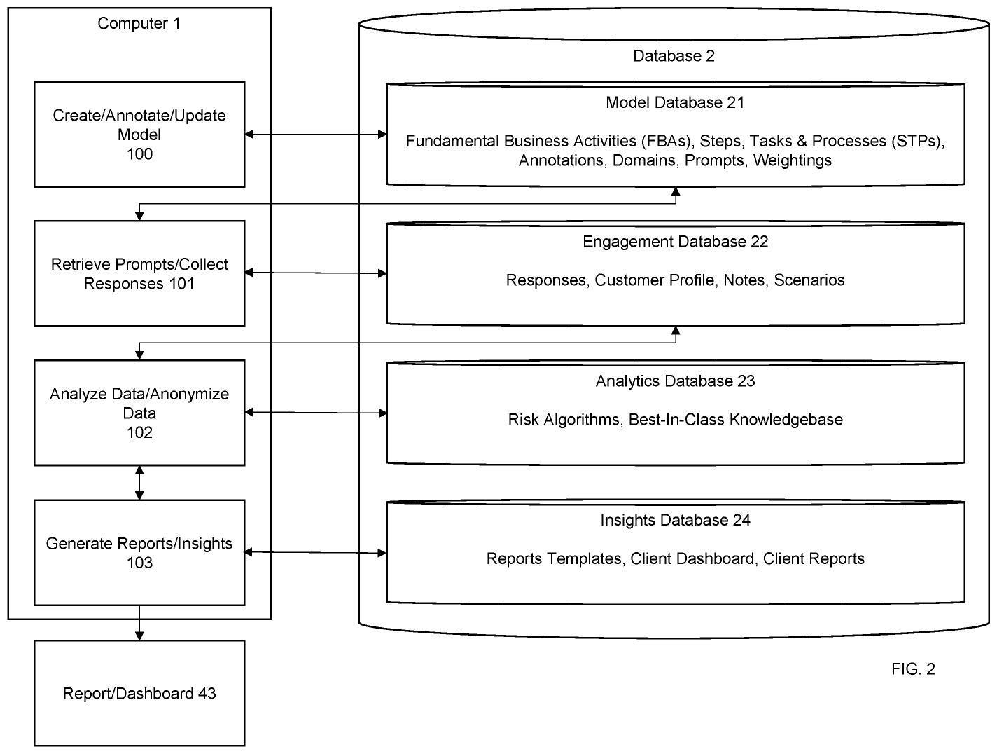

The computer 1 may also be in communication with a database 2. The database 2 may be a storage drive or array accessible to computer 1, or cloud storage. The database 2 may store information regarding the system 10, including the information discussed below. The database may include one or more databases. One example is shown in FIG. 2, with model database 21, engagement database 22, analysis database 23, and insights database 24.

The computer 1 may be in data communication with a consultant device 3. The consultant device 3 may be a computer, laptop, smartphone, tablet, or other electronic device, capable of transmitting data to the computer 1. The consultant device 3 may be associated with consultants, either in-house, partner, or independent, who use the system to perform client engagements designed to uncover the risks described above.

The computer 1 may be in data communication with a user device 4. The user device 4 may be a computer, laptop, smartphone, tablet, or other electronic device, capable of transmitting data to the computer 1. The user device 4 may be associated with a customer, such as an employee at a company, organization, or government entity, that uses the models to uncover risks.

The computer 1 may be in data communication with an admin device 5. The admin device 5 may be a computer, laptop, smartphone, tablet, or other electronic device, capable of transmitting data to the computer 1. The admin device 5 may be associated with an administrator who supports consultants or users and develops new models. The admin device 5 may also be or perform the functions of a consultant device 3.

The computer 1 may receive model information 51 from the admin device 5. The model information 51 may include anything needed to build new models for use with the system. Model information 51 may include at least one of fundamental business activities (“FBAs”), STPs, prompts, weightings, domains, and associations. A model 13 may be created and stored in the database 2. The individual FBAs, STPs, prompts, weightings, domains, and associations may also be stored in the database 2. The computer 1 may receive annotations 35, 52 from consultant device 3 or the admin device 5. Annotations 35, 52 may include an update 13 to an existing model, or FBA, STP, prompt, weighting, domain, or association. The update 13 may be stored in the database 2 as a new model, FBA, STP, prompt, weighting, domain, or association, rather than overwriting an existing one.

The computer 1 may provide a list of models 31 to the consultant device 3. In response, the computer 1 may receive a selection 32 of a model. The computer 1 may retrieve prompts based on the selected model by sending the selection 11 based on selection 32 to the database 2.

The computer 1 may receive prompts 12 from the database 2. Prompts 12 are used to obtain the user's assessment of their knowledge, experience, and past performance (“KEP”) in relation to STPs and/or FBAs. For example, prompts may be for designed scenarios, or “business as usual.” Prompts 12 may be posted as questions, statements, or in other forms.

The computer may send prompts 41, based on prompts 12, to the user device 4. The prompts 41 may be provided verbally or visually. The prompts 41 may be displayed on the user device as part of a graphical user interface. The computer 1 may receive responses 42 to the prompts 41. The responses 42 may be answers to questions, or rankings on the truth of a statement (such as on a scale from −4 to 4), or in another form. Responses 42 may also include basic information about a company or government agency (i.e. name, address, industry, revenue, etc.) and information about the participants and parts of the organization represented in the workshop. Other data included in responses 42 may include information specific to a model, to a scenario, or regarding selected FBAs, and consensus data.

Responses 42 may also include information regarding the emotion of a participant in a workshop, that is, if the person is engaged in the discussion or holding back from fully participating. Based on responses 42 including emotion data, the consultant may be alerted to attempt to uncover the reasons behind the reluctance to fully participate and take corrective steps, or the computer 1 may provide additional prompts. In some embodiments, the computer 1 may generate an emotion flag, which may be used by the computer 1 or provided to the consultant device 3.

In some embodiments, some responses 42 may be received by the computer from the consultant device 3.

The computer 1 may analyze the responses 42 to generate a score. For example, the computer 1 may retrieve best-in-class or comparable company or agency data from the database 2 and compare them against the responses 42. The computer may generate at least one score for the company or agency's KEP, including for any defined scenarios. The core may include ratios or graphs.

The computer 1 may generate a report based on the score. The report may be generated from a report template, which may be retrieved from the database 2. The computer 1 may send the generated report 33 to the consultant device 3. The computer may receive an edited report 34 in response, which includes the consultant device's notes, annotations, etc.

The report 43 may be sent to the user device 4. The report 43 may be sent in document format (e.g., PDF). The report 43 may be provided on a user dashboard accessible via the user device 4 and/or the consultant device 3. The report 43, whether provided as a document and/or dashboard, may be updated to reflect any improvements 44 (received by the computer from the user device 4 or optionally the consultant device 3) that the client makes as they mitigate risks identified in the report 43.

The computer 1 may anonymize the responses 42 and any score or report 33, 34, 43. For example, data identifying a specific company, agency, or employee may be removed. The computer 1 may store the anonymized data in the database 2. For example, the anonymized data may be stored as part of a best-in-class or comparable company or agency database.

FIG. 2 shows an example of a database and database access configuration. In this example, the database may be comprised of several databases, such as SQL databases and tables.

The models database 21 may contain the store components of each model after they have been created, annotated, or updated (100). Components of a model include FBAs, domains, STPs, prompts, weightings, and annotations. FBAs are the core business functions used by a business or agency to conduct operations and contain functions that are both general and specific to the industry (such as Finance, HR, IT processes, etc.). Domains are FBAs grouped into a higher-level set of FBAs (such as strategies, processes, etc.). STPs include specific activities inherent to each FBA that are conducted by the business or government agency (such as Accounting, Change Management, etc.). Prompts are the prompts that will be evaluated by the clients during the workshop (such as “The company has a defined owner for the Change Management process”). Weightings include the specific weights given to each statement in relation to others within the STP, FBA or domain. Annotations are changes made to the prompts by a consultant and are not integrated with the standard statements for each model.

Data from the models database 21 may be provided to the computer 1 when it retrieves prompts and collects responses (101).

The engagement database 22 may include responses collected (101). This may include client specific information such as profile information, participant information and model specific data, answers to questions, or ranking of statements, the specific scenarios defined during a workshop, and any notes taken during the workshop.

The data stored in the engagement database 22 may be analyzed, anonymized and stored (102) in the analytics database 23.

The analytics database 23 includes contains risk algorithms and knowledgebases used to determine the comparative risk scores for each FBA in each model. The data stored in the analytics database 23 includes the formulas/algorithms used to assess a clients risk. It also includes the data used to determine what is “Best-in-Class” for each FBA. Further data used to determine how a company or government agency compares to similar companies or agencies may be stored in the analytics database 23. Best-in-class and comparative information may be derived from anonymized data in the engagement database.

The analyzed data may be used to generate reports/insights (103). The insights database 24 may contain the reports templates and client reports used in each workshop engagement. Report templates may vary for each model. Client reports may include draft, interim, and final reports. The insights database 24 may also contain the data used to create, update, and maintain the client risk dashboard.

The computer 1 may generate a reports and/or a dashboard 43 to deliver risk analytic information.

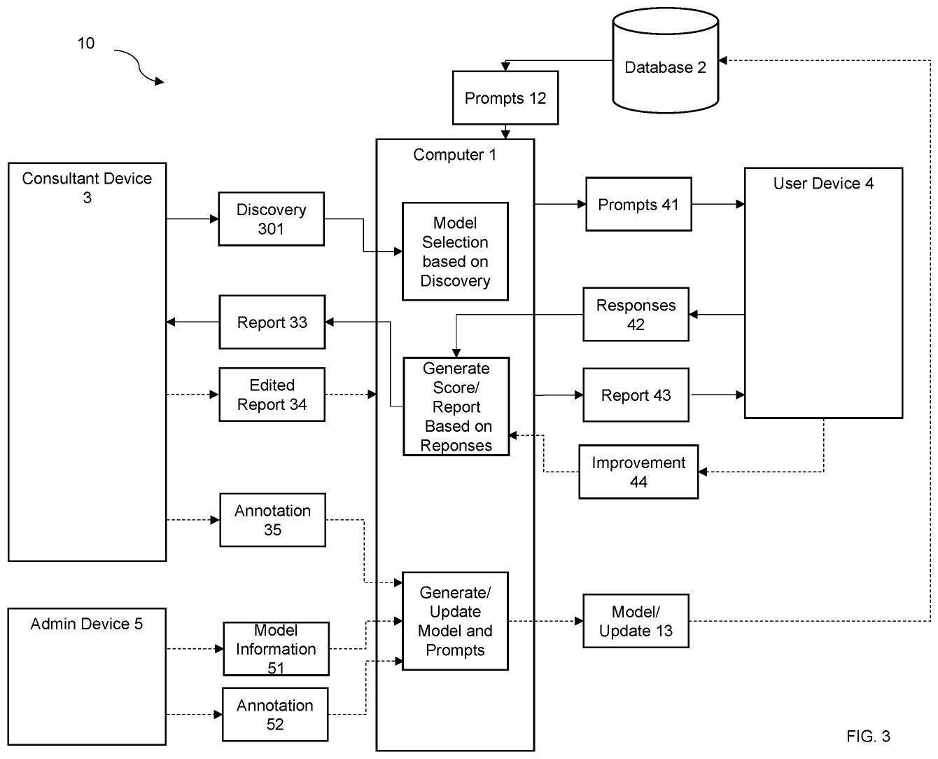

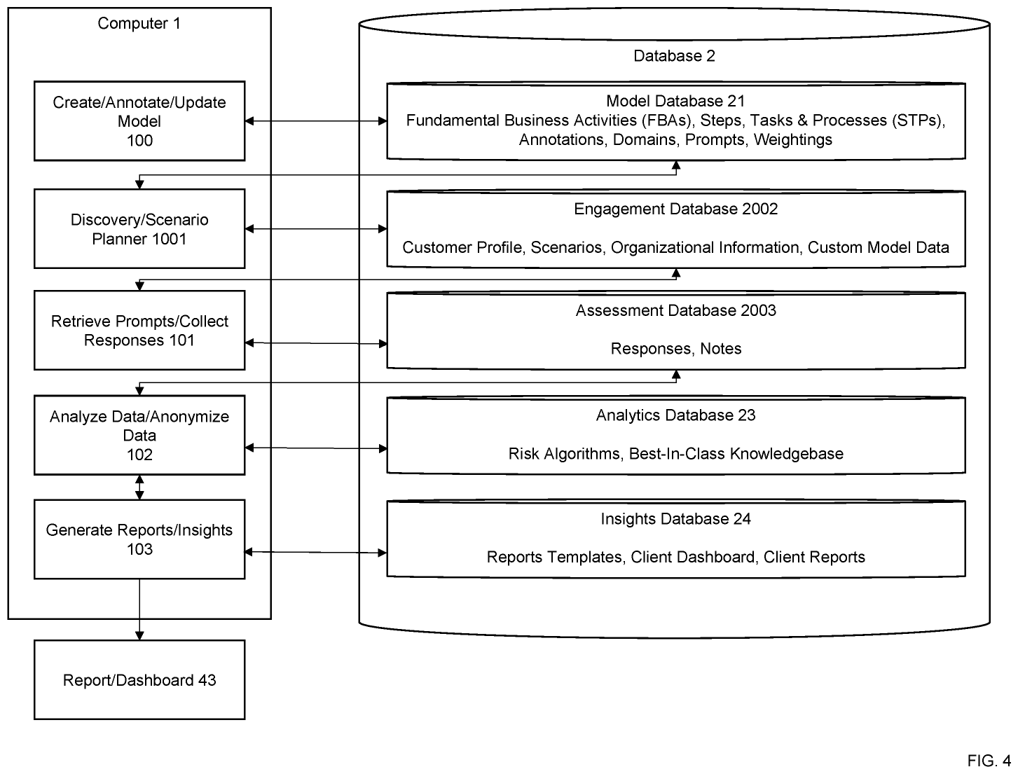

In FIGS. 3 and 4, an alternative embodiment is described. Rather than having the consultant (via consultant device 3) make a selection 32 of a model, the consultant device 3 may provide discovery 301 to the computer 1. Discovery 301 may include information regarding the company, organization, or government entity. Discovery 301 may be determined during an interactive session with employees of the company, organization, or government entity. Software on the computer 1 may be configured to assist in the discovery collection process and build a custom model. Known techniques, including artificial intelligence, may be used to construct the model and additional FBAs and STPs. This replaces the need for the consultant to know and select the most appropriated model based on their own knowledge and understanding of the client needs.

FIG. 4 shows an example of a database and database access configuration based on the system in FIG. 3. In this example, the database may be comprised of several databases, such as SQL databases and tables.

In FIG. 4, data from the model database 21 may be provided to the computer 1 during the discovery/scenario planning process (1001). The engagement database 2002 may include information from the discovery and scenario planning process (1001) and the custom model created by the computer 1. This may include customer profile information, scenarios, organizational information, and custom model data.

The data stored in the engagement database 2002 may be provided to the computer 1 when it retrieves prompts and collects responses (101).

The assessment database 2003 may include responses collected (101). This may include client specific information such as answers to questions, or ranking of statements, and any notes taken during the workshop.

The data stored in the assessment database 2003 may be analyzed, anonymized and stored (102) in the analytics database 23.

Although the invention has been illustrated and described herein with reference to a preferred embodiment and a specific example thereof, it will be readily apparent to those of ordinary skill in the art that other embodiments and examples may perform similar functions and/or achieve user experiences. All such equivalent embodiments and examples are within the spirit and scope of the present invention, are contemplated thereby, and are intended to be covered by the following claims.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect. The present disclosure is to be considered as an example of the invention, and is not intended to limit the invention to a specific embodiment illustrated by the figures above or description below.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components. As used herein, the term “and/or” includes any and all combinations of one or more of the associated listed items. As used herein, the term “application” is intended to be interchangeable with the term “invention”, unless context clearly indicates otherwise. As used herein, the term “virtual space” is intended to mean the set of possible user locations, where a location is specified by parameters assigned to each user. These parameters are modifiable by the user, thereby rendering the space navigable.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings. In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. Furthermore, the specification and claims should be read with the understanding that the virtual space, or spaces, and/or the number of participants using the invention simultaneously which are implied or described herein do not limit the scope of the invention or the claims.

1. A system for providing professional consulting services, comprising:
a computer;
a database including a plurality of models in data communication with said computer;
each model containing prompts;
each model containing analytics, including a best-in-class knowledgebase;
a consultant device in data communication with said computer;
the computer receiving a selection of at least one of said plurality of models from said consultant device;
a user device associated with a company;
the computer transmitting prompts from the selected model to said user device;
responses received by said computer from said user device in reply to the selected model prompts;
a score generated by said computer comparing the responses to the best-in-class knowledgebase of the analytics for the selected model;
the computer anonymizing the responses to be saved as part of the best-in-class knowledgebase for use in a future engagement.

2. The system of claim 1, further comprising:
an administrator device in data communication with said computer;
model information received by said computer from said administrator device;
a model created by software executing on said computer based on the model information;
software executing on said computer for saving the model in the database.

3. The system of claim 2, wherein the model includes at least one of a fundamental business activity (“FBA”), steps, tasks & processes (“STPs”), statements, weightings, and/or domains.

4. The system of claim 3, further comprising:
annotation information received by said computer regarding changes to the model for a particular engagement;
an annotation created by said computer including at least one of a customization statement or association of FBAs and STPs within the model.

5. The system of claim 1, further comprising:
a report transmitted by said computer by said consultant device based on the score;
a finalized report received by said computer from said consultant device, the finalized report saved in said database.

6. The system of claim 5, wherein the report is made accessible to the user device through a web portal.

7. The system of claim 1, wherein the computer receives engagement information including at least one of customer profile information, scenarios, and notes.

8. The system of claim 1, further comprising an emotion flag generated by said computer based on at least one of the responses.

9. (canceled)

10. (canceled)

11. The system of claim 1, wherein the analytics information is regarding a company not associated with a user of the user device.

12. The system of claim 1, wherein the analytics information includes at least one of an algorithm and a comparative knowledge database.

13. The system of claim 1, further comprising:
improvement information received by said computer regarding a company associated with the user device;
an updated score reflecting the improvement information generated by said computer;
a report displayed on the user device reflective of the updated score.

14. A system for providing professional consulting services, comprising:
a computer;
a database including a plurality of models each containing prompts and analytics in data communication with said computer;
a consultant device in data communication with said computer;
the computer customizing a model for an engagement based on information received from said consultant device;
a user device associated with a company;
the computer transmitting prompts from the custom model to said user device;
responses received by said computer from said user device in reply to the selected model prompts;
a score generated by said computer comparing the responses to the analytics for the custom model.

15. The system of claim 14, wherein the custom model includes at least one of a fundamental business activity (“FBA”), steps, tasks & processes (“STPs”), statements, weightings, and/or domains.

16. The system of claim 15, further comprising:
annotation information received by said computer regarding changes to the model for a particular engagement;
an annotation created by said computer including at least one of a customization statement or association of FBAs and STPs within the model.

17. The system of claim 14, further comprising:
a report transmitted by said computer by said consultant device based on the score;
a finalized report received by said computer from said consultant device, the finalized report saved in said database.

18. The system of claim 17, wherein the report is made accessible to the user device through a web portal.
